(19) United States
(12) Patent Application Publication
(10) Pub. No.: US 2026/0176072 A1
(43) Pub. Date: Jun. 25, 2026

(54) METHOD FOR STORING A PLURALITY OF PIECE GOODS IN AN ORDER-PICKING APPARATUS

(71) Applicant: BECTON DICKINSON ROWA GERMANY GMBH, Kelberg (DE)

(72) Inventor: Christoph HELLENBRAND, Kaifenheim (DE)

(21) Appl. No.: 19/128,974

(22) PCT Filed: Sep. 19, 2023
(86) PCT No.: PCT/EP2023/075744

§ 371 Date: May 9, 2025

(30) Foreign Application Priority Data
Nov. 21, 2022 (EP) 22208593.8

(51) Int. Cl. B65G 1/137; G06Q 10/087

(52) U.S. Cl. CPC B65G 1/1373; B65G 1/1371; G06Q 10/08741; B65G 2203/0216

(57) ABSTRACT

A method includes a) determining a unique identifier of a piece good to be stored; b) determining whether the dimensions of the piece good are known; c) positioning a piece good having known dimensions in a placement region according to a predefined placement specification; d) repeating steps a)-c) until it is detected that a last piece good has been placed in the placement region e1) the placed piece goods are moved in a storage direction, and e2) a removal regime is created on the basis of the dimensions of the placed piece goods, the removal regime comprising at least one removal instruction; f1) a removal instruction is executed; f2) a check is carried out as to whether additional removal instructions need to be executed, and steps f1) and f2) are repeated until all removal instructions of a removal regime have been executed.

The present invention relates to a method for storing a plurality of piece goods, in particular drug packages, in an order-picking apparatus.

Automated order-picking apparatuses are often used in pharmacies to be able to store drug packages in a space-saving manner. The drug packages can be stored chaotically in the known order-picking apparatuses suitable for pharmacies, i.e., the drug packages are not stored in the device at predetermined storage locations, but at storage locations where there is just enough storage space. Superfluous empty volume can thus be avoided, and the number of stored drug packages per m2 floor space can be increased significantly. Chaotic storage is regularly used for those drugs or drug packages whose dispensing frequency is rather low (so-called slow-moving items).

For storing a drug package, this is identified using known storage methods, measured if necessary, and placed in a predetermined placement region of a storage device of the order-picking apparatus. The drug package is then moved into an access region of a gripper, as is known for example from EP 3 431 421 A1, of an operating device within the order-picking apparatus, in which the gripper picks up the drug package and moves it to a storage location specified by a control device-thus, always only one drug package is processed per storage operation.

It is also known to first arrange a plurality of identical drug packages identically in the placement region and then to move them together into the order-picking apparatus, where they are then gripped together by the gripper and fed together to one or more storage locations. This method is used in particular for so-called fast-moving items (drug packages with a high dispensing frequency) that are regularly stored in shaft systems that enable rapid dispensing. Storing a plurality of identical drug packages is much faster than storing a plurality of different drug packages, since in this case the same process has to be repeated for each drug package.

The object of the present invention is therefore that of providing a method with which a plurality of non-identical piece goods can also be stored in a time-saving manner.

This object is achieved by a method according to claim 1. In the method according to the invention for storing a plurality of piece goods in an order-picking apparatus having at least one row of shelves having a plurality of storage locations, a control device, a storage device, and a gripper for piece goods, first, a) a reading device coupled to the control device is used to determine a unique identifier of a piece good to be stored. The unique identifier includes at least one unique product code that uniquely identifies the piece good to be stored. For example, if drug packages are stored, the unique identifier can include the PZN as a product code. The PZN is an eight-digit, numerical, and “non-descriptive” number that uniquely identifies drug products according to their name, dosage form, active ingredient strength, and package size. The reading device can be connected to the control device of the order-picking apparatus in a wired or wireless manner, or can be connected to it for the reading process as described above.

In a next step b), the unique identifier read-in is used to determine, in a database, whether the dimensions (height, width, depth) of the piece good are known, and then, in a step c), the piece good having known dimensions is positioned in a placement region of the storage device, according to a predefined placement specification.

The placement region is a region marked by at least one marking that shows a user where a piece good should be placed on the storage device. Markings on the storage device itself, a light barrier, markings on the side of the storage device itself, or an illuminated region are conceivable as markings; in addition, further markings are also conceivable. However, the arrangement may not be carried out in just any way, but, rather, according to a specified placement specification, which states, for example, that the piece goods must be arranged in the placement region in the longitudinal direction orthogonally to a storage device from “left to right.” This ensures that the control device knows the sequence and orientation of the arranged piece goods-this is essential for subsequent method steps.

According to a step d), steps a)-c) are performed until it is detected that a last piece good has been placed in the placement region. The way in which the placement of the last piece good is exactly detected is not essential for the invention as such; examples are described further below. How often steps a)-c) are carried out depends upon the dimensions of the placed piece goods, the width of the storage device, and the placement specifications. The method according to the invention aims, according to the invention, to enable the placement of a plurality of different piece goods.

After the placement of the last piece good has been detected, in a step e1), the placed piece goods are moved with the storage device in a storage direction, and (step e2)) a removal regime for the gripper is created on the basis of the dimensions of the placed piece goods, wherein the removal regime comprises at least one removal instruction, and each removal instruction includes one or more piece goods, wherein the order of steps e1) and e2) is unimportant; they can also be performed or initiated simultaneously.

After creating the removal regime and moving the piece goods in the storage direction to the intended removal location, (step f1)) a removal instruction is executed in that a number of piece goods corresponding to the current removal instruction are moved by the gripper from the storage device and stored.

Then (step f2)) a check is carried out as to whether additional removal instructions need to be executed, and steps f1) and f2) are performed until all removal instructions of a removal regime have been executed.

As already noted above, the control device knows the exact arrangement of all the piece goods due to the determination of the unique identifier of each piece good, the dimensions known for each placed piece good, and the placement specification. Depending upon the dimensions of the piece goods, a plurality of “placement patterns” are conceivable in the placement region, which make it necessary to adapt the retrieval with the gripper; if, for example, five piece goods are arranged in the placement region from left to right and the central one is the widest in relation to the storage direction, it is very likely that not all piece goods can be removed with one gripping movement when using a conventional jaw gripper, but, rather, certainly, only the three “right” ones. The removal regime to be created according to the invention would then comprise two removal instructions, wherein three piece goods are intended to be removed according to the first removal instruction, and two piece goods are intended to be removed according to the second removal instruction. Accordingly, a minimum of one and a maximum of as many removal instructions as the number of piece goods placed must be processed.

Although the free placement of the piece goods (apart from the placement specification) delays the storage of the piece goods after the last piece good has been detected, the storage time can be used to place further piece goods, so that the delayed storage due to the possibly multiple removal instructions does not delay the overall process, but, rather, accelerates it overall due to the possibility of storing a plurality of non-identical piece goods. The method according to the invention is also more user-friendly, because it is less monotonous, and the user does not have to pay attention to a specific arrangement according to size specifications when placing the piece goods.

As can be seen from the above description of the method according to the invention, only piece goods with known dimensions can be stored according to the invention. The dimensions of a piece good are determined, using the unique identifier, in a database. If no corresponding dimensions are found in the database after determining a unique identifier, e.g., because the unique identifier has not yet been stored, the piece good cannot be stored immediately. This can be indicated to a user by, for example, a signal, whereupon the user stores the piece good for, for example, later processing. Alternatively, the lack of knowledge of the dimensions can be made clear, for example, by not marking the placement region. In a preferred embodiment of the method according to the invention, if the dimensions of a piece good are unknown, said piece good is measured, and the dimensions are stored in the database with the determined unique identifier. The measurement can be carried out “externally”—for example, on a measurement device coupled to the control device.

In order to accelerate the storage of a piece good with unknown dimensions and to make it as simple as possible for the user (and thus as error-free as possible), a preferred embodiment provides that, if the dimensions are not known, the piece good be measured in that piece goods placed in the storage area are stored according to steps e1)-f2), the piece good with unknown dimensions is placed in the placement region and automatically measured, and the dimensions are stored in the database. The piece good with the unknown dimensions will then be interpreted in such a way that it marks the previous piece good as the “last” piece good and thus starts the storage according to the invention of the previously placed piece goods. Now, the piece good that has not yet been measured can be measured during storage, and further piece goods can be added and stored according to the invention.

As already explained above, it is irrelevant for the invention itself how exactly the arrangement of a final piece good is detected. In a preferred, technically very simple, embodiment, it is provided that the placement of a last piece good be detected by a user transmitting a corresponding input to the control device.

Alternatively, it can be provided that the placement of a last piece good be determined by means of a sensor assigned to the placement region. This embodiment is more user-friendly, but may be more technically complex.

According to the invention, it is essential that the piece goods are arranged according to a placement specification (e.g., from left to right and long-side orthogonal to the storage direction). The placement specification can be adapted to the design of the order-picking apparatus and the storage device, as well as to the user's preferences (left to right, right to left). However, it may be the case that a user arranges a piece good incorrectly, i.e., not according to the placement specification. In order to be able to determine a type of possible incorrect arrangement without too much effort, it is provided in a preferred embodiment that, after the detection of the placement of the last piece good in the placement region, a width of the plurality of the placed piece goods be determined and this width be compared with the largest width of the placed piece goods, and a signal be output if a deviation exceeding a limit value occurs. If, for example, all the placed piece goods are less than 5 cm wide and between 10 and 15 cm long, and the placement specification states that the piece goods are to be stored with their long sides orthogonal to the storage device, a determined width of >5 cm can indicate only incorrect arrangement by a user. If this is detected, the user is for example asked to make corrections or to rearrange all the piece goods.

The unique identifier comprises at least one product code of the piece good, to which the dimensions of the piece good are linked. However, the unique identifier need not be limited to the product code.

For example, a plurality of piece goods have an expiration date. In a preferred embodiment, in which the unique identifier comprises such an expiration date, it is provided that the expiration date of the piece good to be stored be compared with the expiration date of an identical piece good, and, if the piece good to be stored has an earlier expiration date, the storage location of the piece good to be stored be optimized and/or the retrieval sequence be adjusted in such a way that the piece good with the earlier expiration date is preferentially retrieved.

Piece goods may also include individual serial numbers, which may be stored in databases. In a preferred embodiment of the method according to the invention, in which the unique identifier comprises a unique serial number, it is provided that the unique serial number be verified using a database and the storage method be stopped in the event of an incorrect verification. In this way, counterfeit piece goods, for example, can be detected.

In the following, the method according to the invention is described in more detail with reference to the accompanying drawings, in which:

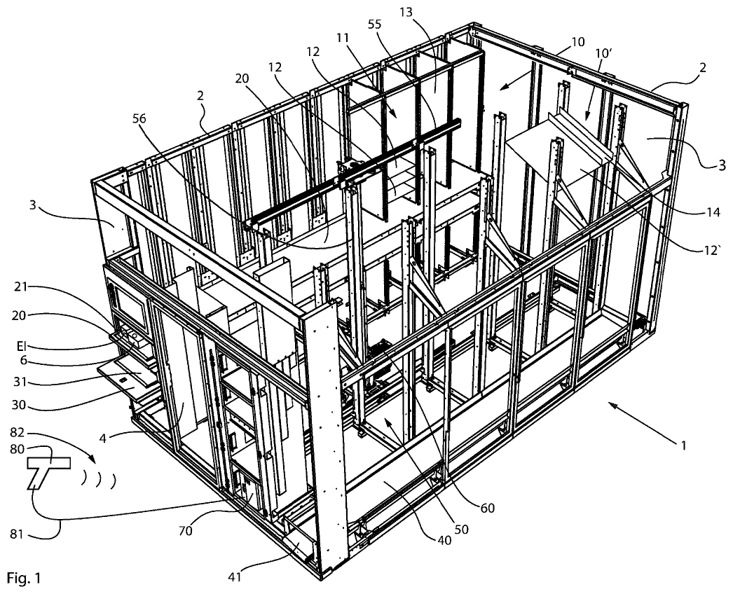

FIG. 1 is a perspective view of an order-picking apparatus by means of which the method according to the invention can be carried out,

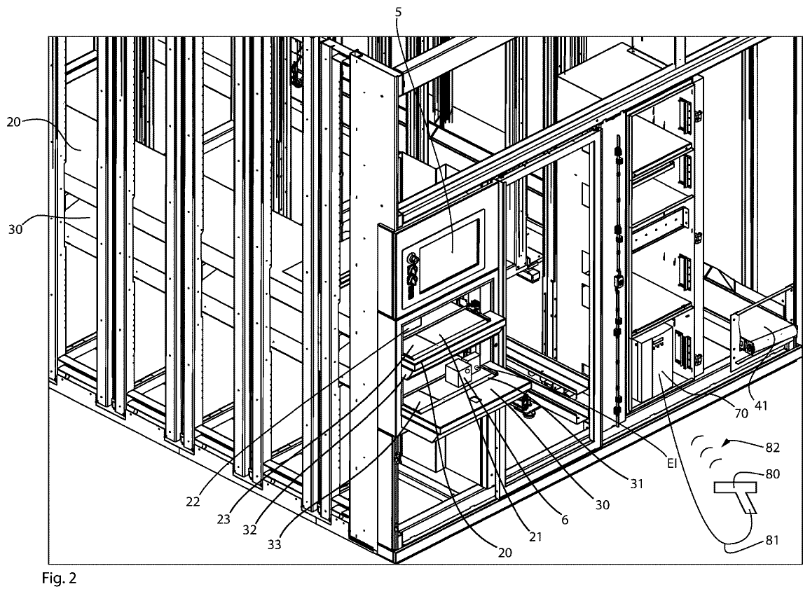

FIG. 2 is a detail view of the front region of the order-picking apparatus,

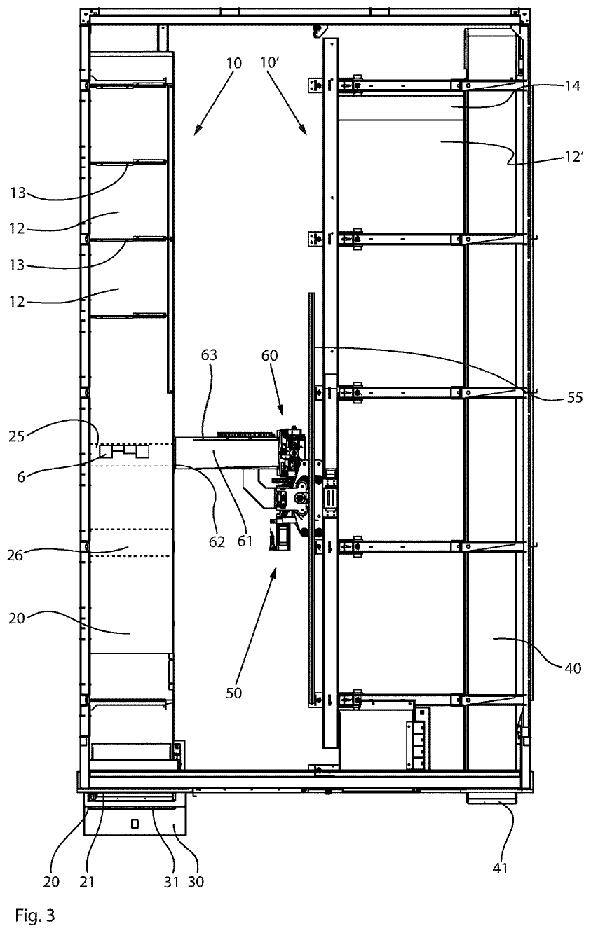

FIG. 3 is a plan view of the order-picking apparatus,

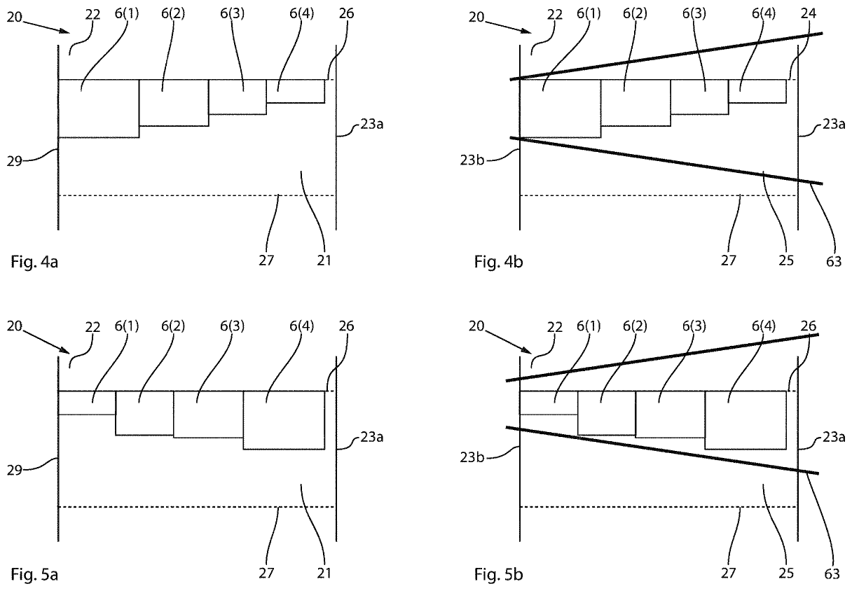

FIG. 4a-6b illustrate different placement and removal situations,

FIGS. 7a and 7b show a placement and removal situation with an incorrect arrangement of piece goods that does not correspond to the placement specifications, and

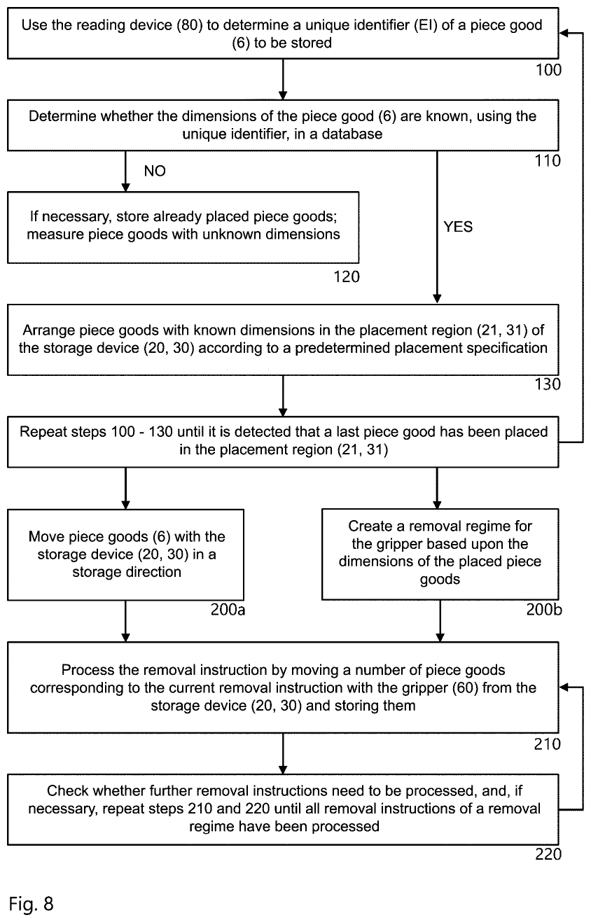

FIG. 8 illustrates the sequence of the method according to the invention.

FIG. 1 is a perspective view of an order-picking apparatus 1 with which the method according to the invention can be carried out. The order-picking apparatus 1 is described below only by way of example and for a better understanding of the following detailed description of the method according to the invention. The order-picking apparatus shown in FIG. 1-3 is used to store drug packages as piece goods, and, in the following, the term drug package is also used (by way of example, for the term piece goods).

The order-picking apparatus 1 comprises a frame structure 2 to which a plurality of cladding elements 3 are attached. For the sake of clarity, a plurality of the cladding elements and some elements of the frame structure 2 have been omitted. The order-picking apparatus 1 comprises a first row of shelves 10 with a plurality of shelves, each of which has a plurality of shelf bases 12 arranged one above the other and extending in a horizontal plane with a plurality of storage locations (only three shelf bases 12 are shown in FIG. 1; further shelf bases are arranged above, below, and next to those shown). The individual shelves 11 of the first row of shelves 10 are formed by shelf walls 13 and a plurality of the aforementioned shelf bases 12. In the example shown, all the front edges (loading edges) of the shelf bases are arranged in a vertical plane, which simplifies the storage and removal of piece goods or drug packages into and from the shelf bases. The shelf bases shown are designed for chaotic storage of drug packages.

In the order-picking apparatus shown, a second row of shelves 10′ is provided, opposite the first row of shelves 10, which, however, is only indicated, for reasons of clarity; only individual elements of the support structure for this row of shelves and one shelf base 12′ with a storage shaft 14 for single-sort storage are shown. The storage shafts of the order-picking apparatus are intended for the storage of fast-moving items and are not relevant to the present invention.

The order-picking apparatus shown by way of example comprises two storage devices 20, 30 which are arranged one above the other and are integrated into the first row of shelves 10, so that shelf bases 12 are provided above and below the two storage devices 20, 30. The storage devices 20, 30 protrude from the front of the order-picking apparatus and each comprise on the protruding part a placement region 21, 31, on which drug packages can be placed for storage. In FIG. 1, two drug packages 6 are arranged in the placement region 21 of the upper storage device 20.

The placement regions 21, 31 are not components as such, but, rather, special regions of the storage devices in which drug packages are arranged according to the placement specifications. The placement regions can be formed, for example, by markings on a storage device designed as a conveyor belt. Alternatively, a light barrier can mark a placement region. Finally, it is conceivable that a movable barrier define a placement region.

Between the illustrated first row of shelves and the merely indicated second row of shelves, an operating device 50 with a gripper 60 is provided, which can be moved horizontally and vertically on a guide and which gripper is described in more detail with reference to FIG. 3. The gripper 60 can be moved along a merely indicated horizontal guide 55 and a vertical guide 56 in an aisle between the two rows of shelves.

Furthermore, a retrieval device 40 is arranged in the order-picking apparatus, which is designed here as a conveyor belt and is indicated between the second row of shelves and the right-hand outer wall of the order-picking apparatus. Drug packages that are moved onto the retrieval device are moved to a removal region 41 of the retrieval device via the retrieval device. The drug packages can be moved onto the retrieval device by, for example, moving them onto the retrieval device using the operating device 50, if necessary with the interposition of an auxiliary retrieval path (not shown). In the case of the inclined storage shafts, the drug packages can be moved to the retrieval device simply by triggering a triggering device located at one end of a storage shaft. In such a case, the drug packages simply fall onto the retrieval device due to gravity.

In FIG. 1, a control device 70 is arranged in the front region of the order-picking apparatus, which control device is coupled to the operating device, the sensors and sensor systems, and usually the storage devices and the retrieval device. In the middle of the front region of the order-picking apparatus, a door opening 4 is provided, through which the device can be entered for maintenance purposes and in the event of malfunctions.

FIG. 1 also symbolically indicates a reading device 80 which can be coupled to the control device 70 via a line 81 or via a wireless connection 82. The reading device 80 determines the unique identifier EI (indicated as a circle on each drug package) of each drug package before it is arranged in the placement region. The exact nature of the unique identifier and thus the reading device is irrelevant to the present invention. What is essential is that each drug package to be stored using the method according to the invention comprise such a unique identifier, and that a unique identifier uniquely identify a drug package. The exact structure and information content of a unique identifier has already been briefly explained above and will be described in more detail with reference to the method according to the invention.

FIG. 2 is a detail view of the front region of the exemplary order-picking apparatus, wherein, in this view, the placement region of the storage device 20, 30 is visible in particular. In FIG. 2, two drug packages 6 are arranged in the placement region 31 of the lower storage device 30. In the example shown, above the placement region 21, 31, a support detection sensor 22, 32 is indicated in each case, with which a detection region 23, 33 of a placement region 21, 31 is monitored.

As soon as a piece good is placed in a detection region 23, 33, or at least partially protrudes into the detection region, a corresponding signal is transmitted to the control device 70, which identifies the “last” piece good. How far a drug package must extend into a detection region in order to trigger the aforementioned signal can be set on the control device or the support detection sensor or the sensor system itself.

In FIG. 2, an input and/or output device 5 is also indicated above the upper storage device 20, with which information regarding the drug packages to be stored can be displayed and/or entered.

FIG. 3 is a plan view of the exemplary order-picking apparatus, wherein a large part of the support frame 2 is omitted for the sake of clarity. On the left-hand side, the storage device 20 can be seen, which leads from an outer region to deep into the order-picking apparatus. In a removal region 25d of the storage device 20, which is indicated by dashed lines, four drug packages 6 are arranged, wherein the arrangement corresponds exactly to the arrangement of the drug packages in the placement region. This illustration also shows that the storage device is integrated into the first row of shelves 10, since, in the “upper” region, shelf bases 12 and shelf walls 13 are indicated above the storage device 20. On the right-hand side, the retrieval device 40 with the removal region 41 can be seen, and the second, only indicated, row of shelves 10′ adjoins towards the inside of the order-picking apparatus. The horizontally and vertically movable operating device 50 with gripper 60 is arranged between the first row of shelves 10 and the second row of shelves 10′, wherein the horizontal guide 55 normally extends over the entire length of the order-picking apparatus in order to be able to reach all shelf bases of the device with the operating device. The gripper 60 comprises a deposit table 61 with a front edge 62, over which drug packages are moved onto the deposit table 61 by indicated clamping jaws 63.

FIG. 4a-6b illustrate various placement situations of a plurality of drug packages 6(1)-6(4), wherein, in FIG. 4a-6a, the placement region, after placement of all drug portions, is shown, and, in FIG. 4b-6b, the drug portions in the removal region 25 are shown, wherein clamping jaws 63 of the gripper (not shown) are additionally indicated in FIG. 4b-6b.

FIG. 4a-6a show various placement situations, namely according to the placement specification “from left to right, long side to the upper marking line of the placement region.” In each of the figures, the placement region 21 of the storage device 20 is illustrated schematically. The storage device 20 comprises a conveyor belt 22, on which two markings 26, 27 define the placement region 21. In the case of such a marking of the placement region, the conveyor belt comprises a plurality of markings, each of which is moved with the placed drug portions in the storage direction/longitudinal direction of the storage device. In the case of marking by, for example, a light barrier, this is not necessary. In the example shown, the storage device comprises a side wall 29, against which the first drug package 6(1) is or can be placed. The following drug packages are placed next to those on the left, until the placement region is largely filled. The conveyor belt 21 is “open” at its right-hand edge 23a.

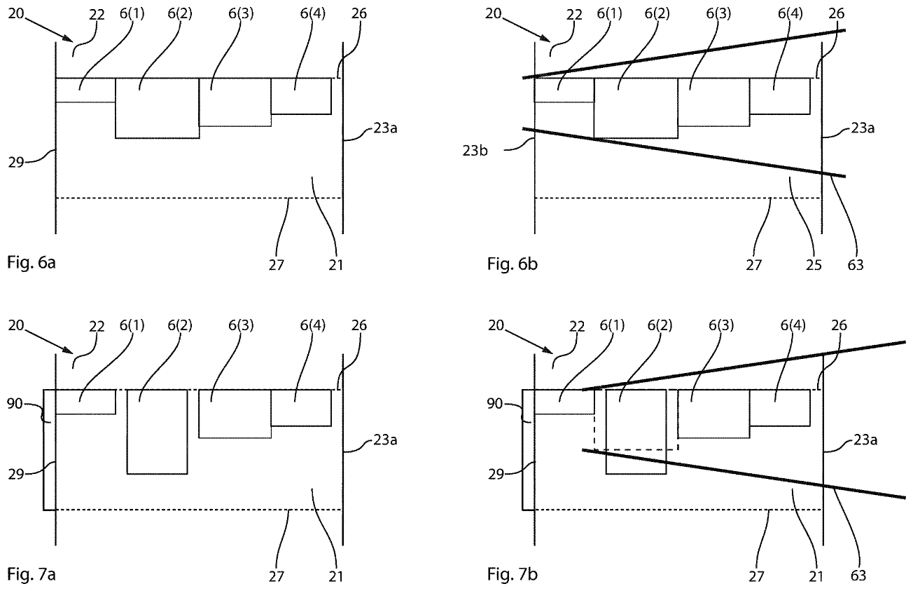

In FIG. 4a, the drug portions become “narrower” from left to right (relative to the storage direction or longitudinal direction of the storage device 20). In FIG. 5a, the drug packages become “wider” towards the right; in FIG. 6a, the second drug package from the left (6(2)) is the widest.

In FIG. 4b-6b, the same drug packages are indicated in the removal region 25, in which the storage device 20 is also open at the left-hand edge 23b. FIG. 4b-6b essentially show the situation from FIG. 3, but the clamping jaws 63 of the gripper (not shown) are also indicated.

Due to the dimensions of the placed drug packages 6(1)-6(4), the design of the gripper (clamping jaws), and the removal direction (gripper accesses the drug packages from the “right”), it follows that only the drug packages as shown in FIG. 4a can be safely moved with the gripper in one gripping movement onto the (not shown) deposit table of the gripper. The widest drug package 6(1) is held securely by the clamping jaws and pushes the drug packages 6(2)-6(4) safely onto the deposit table.

The control device knows all of the aforementioned framework conditions, as well as the dimensions of all placed drug packages and their positions. Based upon this, a removal regime is created, which in FIG. 4b can be very simple and may possibly include only one removal instruction, viz., moving all drug packages onto the deposit table. Depending upon the available storage locations, however, it may also be useful or necessary in such a case to remove the drug packages that can be removed in one removal process in two steps/removal instructions (e.g., if it is necessary to store 6(3) before 6(1)).

In the situation shown in FIG. 5a, the drug packages become wider towards the right. It cannot be guaranteed that a drug package will not be left behind when attempting to use the clamping jaws to move all the drug packages onto the deposit table. In this case, the removal regime includes four removal instructions-specifically, each for removing one drug package.

FIG. 6a shows another situation in which the drug packages are arranged “in a jumble.” The precise arrangement (as well as the remaining framework conditions) show that the drug packages can be safely removed using a removal regime that includes two removal instructions—first the drug packages 6(2)-6(4), then the drug package 6(1).

FIG. 7a shows a placement situation in which the drug packages have not been arranged according to the placement specification—the drug package 6(2) is not positioned with its long side at the marking 26. As a result, the control device (which assumes that the placement specification is always followed) may no longer be able to store the drug package 6(2) because the storage location provided for the drug package was determined based upon the orientation of the drug package corresponding to the placement specification. Furthermore, it may happen that the attempt to remove the drug packages 6(2) damages the clamping jaws, so that these have to be pivoted further than necessary (and possible).

In the example shown, the order-picking apparatus therefore comprises a measuring device 90, which is arranged on the left-hand edge of the storage device 20, with which the maximum “width” of the drug packages can be determined “from the left.” In the situation of FIG. 7a, it can be seen that the arrangement of the drug packages cannot fully correspond to the placement specification—the maximum width (of the drug package 6(2)) is larger than it should actually be (drug package 6(2) shown by dashed lines). However, an incorrect arrangement of, for example, the drug package 6(4) cannot be detected in this way. In alternative examples, a measuring device can be arranged on the left and right, although even in this case situations can arise in which not every misalignment can be detected.

In the following, a preferred embodiment of the method according to the invention will be described in more detail with reference to FIG. 8. The method as such can be carried out with an order-picking apparatus as described by way of example in FIG. 1-3 . First, according to a step 100, a unique identifier EI of a piece good 6 to be stored is determined using a reading device 80 coupled to the control device 70. The unique identifier includes at least one unique product code that uniquely identifies the piece good to be stored. For example, if drug packages are stored (which is assumed below), the unique identifier can include the PZN as a product code. The PZN is an eight-digit, numerical, and “non-descriptive” number that uniquely identifies drug products according to their name, dosage form, active ingredient strength, and package size. The unique identifier can be structured according to the “Rules for the encoding of drugs subject to verification on the German market.” A detailed description of the rules is published, for example, at “https://www.securpharm.de/wp-content/uploads/2018/08/securPharm_Codierung_Regeln_DE_V2_03.pdf”. However, the manner in which the unique identifier is constructed is not essential for the present invention. All that is essential is that the unique identifier for the piece good be unique, so that general piece-good-specific information can be stored and retrieved via the identifier.

In a step 110, the unique identifier is then used to determine, in a database, whether the dimensions of the piece good are known. The database can be stored on the control device itself, but it is conceivable that it be a cloud-based database that can be accessed by a plurality of order-picking apparatuses. With the method according to the invention, only piece goods (drug packages) with known dimensions can be stored, since these are necessary in order to be able to properly remove the piece goods from the storage device in a subsequent method step. If the dimensions are not known, they must be determined and saved in step 120; the measurement can, for example, be carried out by the user using a separate measuring station. Alternatively, the measuring can be carried out automatically using the order-picking apparatus, as described further below.

In the (usual) case that the dimensions are known, in a step 130, the piece good with known dimensions is arranged in a placement region 21, 31 of the storage device 20, 30 according to a predetermined placement specification. According to the invention, a user is thus not allowed to place the piece goods arbitrarily, but, rather, must do so according to the placement specification, since this is the only way to ensure that the control device “knows” where and how which piece goods are arranged in the placement region. For example, the placement specification may specify that the piece goods be arranged “from left to right” in the placement region, and specifically with the long side orthogonal to the subsequent storage direction, i.e., the longitudinal direction of the storage device (see in this regard FIG. 1-3; the storage direction corresponds to the longitudinal orientation of the storage devices 20, 30). If no placement specification were observed when arranging the piece goods (with different dimensions), the control device would have no information about how the piece goods are arranged; safe removal of the piece goods with the gripper would not be possible. It is conceivable to install a sensor system that, after a plurality of piece goods have been placed, identifies the piece goods based upon their size-for example, using an image taken from above. However, if two different piece goods with the same dimensions are placed, identification based upon an image is difficult and prone to errors.

The aforementioned steps 100-130 are now repeated until it is detected that a last piece good has been placed in the placement region 21, 31. The user can indicate by a signal that a last piece good has been placed, or a sensor system can be provided that covers a specific portion of the placement region; as soon as a piece good is placed in it, it is declared “the last piece good.”

It is also conceivable that the detection of a piece good with unknown dimensions be interpreted in such a way that the previously placed piece good with known dimensions is marked as “the last” piece good-with the result that all previously placed piece goods are processed according to the steps described below. As soon as the placement region is free, the piece good with unknown dimensions can be arranged in the placement region and measured automatically.

The measurement can be carried out in many ways known to a person skilled in the art-for example, using laser arrays arranged above and to the sides or other techniques known from the logistics industry.

In order to carry out the measurement as cost-effectively as possible, to determine the height, an ultrasonic sensor, for example, can be used, under which the piece good is moved for measurement. For this purpose, measured values are constantly determined as the piece good moves under the ultrasonic sensor, and the “highest” value is taken as the height of the piece good.

In order to determine the width (width refers to the extension in the storage direction) of a piece good, a light barrier can be mounted, for example, on the storage device, which light barrier acts orthogonally to the storage device. If a piece good is moved from the placement region in the storage direction (further into the order-picking apparatus), there is initially a first signal change (positive edge) at the light barrier. The position of the storage device (e.g., a storage belt) is saved at this signal change. If the piece good leaves the light barrier, there is another signal change (negative edge). The position is also saved for this purpose. The difference between the two positions determines the width of the piece good.

One or two ultrasonic sensors can be used to determine the depth (here, the longest side of a piece good). As with the height measurement, to determine the depth, the piece good is moved past the ultrasonic sensor(s) arranged to the side of the storage device, in the storage direction, and a value is constantly determined; the extreme value(s) then determine(s) the depth of the piece good. If the piece good is placed at a stop next to the storage device, one ultrasonic sensor on the opposite side is sufficient; if two ultrasonic sensors are used, the piece good can be arranged as desired (in a specified orientation) in the placement region.

As soon as it is detected that the last piece good is arranged in the placement region, in a step 200a, the placed piece good(s) 6 is or are moved with the storage device 20, 30 in a storage direction. In parallel, in step 200b, a removal regime for the gripper 60 is created based upon the dimensions of the placed piece good(s), wherein the removal regime comprises at least one removal instruction, and wherein each removal instruction comprises one or more piece goods.

As already described with reference to FIG. 4a-6b, the method according to the invention enables a user to arrange a plurality of different piece goods in the placement region, and these are stored automatically. Although it is necessary for a user to observe the placement specification when arranging the piece goods in the placement region, the method according to the invention, due to the determination and use of the removal regime, does not require the piece goods to be placed in a specific order with regard to their dimensions. This speeds up storage considerably, since a user can simply pick up a piece good at random from a plurality of piece goods and arrange it in the placement region.

In FIG. 4a, the removal regime includes a removal instruction that states that the gripper can remove all the placed piece goods together—i.e., it can move them onto the deposit table using the clamping jaws. In FIG. 4b, the removal regime could comprise four removal instructions, each comprising one piece good; the piece goods are removed from “right to left” with the gripper, since it cannot be guaranteed that, when more than one piece good is removed, the “left” one might not be taken along during the movement to the placement table. In FIG. 6a, the removal regime should include two removal instructions; the first includes the three right-hand piece goods, the second the left-hand piece good.

After the piece goods have been moved onto the gripper's deposit table, they are placed in storage locations determined by the control device in accordance with work steps known to a person skilled in the art.

1. A method for storing a plurality of piece goods in an order-picking apparatus, having at least one row of shelves with a plurality of storage locations, a control device, a storage device, and a gripper for piece goods, the method comprising:
a) determining, by a reading device coupled to the control device, a unique identifier of a piece good to be stored;
b) determining, based on the unique identifier, in a database, whether the dimensions of the piece good are known;
c) arranging a piece good having known dimensions in a placement region of the storage device, according to a predefined placement specification;
d) repeating steps a)-c) until it is detected that a last piece good has been placed in the placement region;
e1) moving the placed piece goods in a storage direction with the storage device;
e2) creating a removal regime for the gripper on the basis of the dimensions of the placed piece goods, wherein the removal regime comprises at least one removal instruction, and wherein each removal instruction includes one or more piece goods;
f1) executing a removal instruction is so that a number of piece goods corresponding to a current removal instruction are moved by the gripper from the storage device and stored;
f2) carrying out a check as to whether additional removal instructions need to be executed; and
repeating steps f1) and f2) until all removal instructions of a removal regime have been executed.

2. The method of claim 1,
wherein if the dimensions of a piece good are unknown, this piece good is measured and the dimensions are stored in the database.

3. The method of claim 2,
wherein a piece good is measured by storing piece goods arranged in the placement region according to steps e1)-f2), the piece good with unknown dimensions is arranged and measured in the placement region, and the dimensions are stored in the database.

4. The method of claim 1, wherein a placement of a last piece good is detected by a user transmitting a corresponding input to the control device.

5. The method of claim 1, wherein the placement of a last piece good is determined by means of a sensor assigned to the placement surface.

6. The method of claim 1, wherein, after detecting the placement of the last piece good in the placement region, a width of the plurality of the placed piece goods is determined and this width is compared with the largest width of the placed piece goods, and a signal is output if a deviation exceeding a limit value occurs.

7. The method of claim 1, wherein the expiration date of the piece good to be stored is compared with the expiration date of an identical piece good, and, if the piece good to be stored has an earlier expiration date, and one of the storage location of the piece good to be stored is optimized and/or the retrieval sequence is adjusted in such a way that the piece good with the earlier expiration date is preferentially retrieved.

8. The method of claim 1, wherein the unique identifier comprises a unique serial number
that is verified against a database, and the storage method is stopped in the event of an incorrect verification.
